(19) United States
(12) Patent Application Publication
(10) Pub. No.: US 2010/0119862 A1
(43) Pub. Date: May 13, 2010

(54) Fiber Wrapped Pipe Weld Seam

(75) Inventor: Stuart L. Wilson, Pearland, TX (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/615,724

(22) Filed: Nov. 10, 2009

Related U.S. Application Data
(60) Provisional application No. 61/112,799, filed on Nov. 10, 2008.

(51) Int. Cl. B32B 1/08

(52) U.S. Cl. 428/586

(57) ABSTRACT

A reinforced pipe weld seam is provided wherein raised members are located a distance from each side of the weld seam. The weld seam and raised members are covered by a generally longitudinally aligned layer of fibers. In a preferred embodiment, the longitudinally aligned layer of fibers is covered by a layer of circumferentially aligned layers of fibers.

### CROSS-REFERENCE TO RELATED APPLICATION

This nonprovisional patent application claims the priority to and the benefit of U.S. provisional patent application Ser. No. 61/112,799, titled, “Fiber Wrapped Pipe Weld Seam,” filed Nov. 10, 2008, which is hereby incorporated by reference.

### FIELD OF THE INVENTION

Embodiments of the present invention relate generally to reinforcing weld seams to increase strain capacity. Particularly, various embodiments of the present invention provide for reinforcing a weld seam between two sections of metal pipe by using fibers.

### BACKGROUND

As the worldwide demand for natural gas and oil grows, the need to develop remotely located sources of such hydrocarbons becomes increasingly important. Often, such development requires infrastructure, such as pipelines, be built to effectively deliver the hydrocarbons to locations where it can be processed or sold. Because oil and gas pipelines cover considerable distances, they can be subject to significant ground movement from seismic activity or pipe movement from frost heave, thaw settlement and thermal expansion. Such movements place strain on the pipe which must be accounted for in the pipeline design. If the local strains expected to be applied to the pipeline (strain demand) exceed the capacity of the pipeline (strain capacity) failure occurs.

The strain capacity of the pipe body is usually not the limiting factor; rather the areas where the pipes are butt welded together tend to have lower strain capacity than the pipe body and, this limits the overall strain capacity of the pipeline.

When pipes are butt welded together, geometrical discontinuities and weld defects are introduced. When present, geometrical discontinuities and weld defects detrimentally affect the compression and tensile strain capacity of the pipeline. It is increasingly more important to address this issue for large diameter, thinner wall pipelines made from higher strength steels.

### SUMMARY

The present invention relates generally to the treatment of sour gas and more particularly, but not by way of limitation, embodiments of the present invention include methods and systems for treating hydrogen sulfide rich sour gas through cryogenic fractionation.

In one embodiment of the present invention, there is provided a reinforced pipe comprising a first metal pipe section butt welded to a second metal pipe section to form a weld seam; a first raised member located a first distance away from the weld seam on the first pipe section; a second raised member located a second distance away from the weld seam on the second metal pipe section; and a first layer of fibers disposed generally longitudinally along the pipe so that the first layer covers the first raised member, the weld seam and the second raised member.

In another embodiment of the present invention the first and second raised members are raised rings positioned circumferentially around the pipe.

In still another embodiment of the present invention, the first layer is covered by a second layer of fibers disposed generally circumferentially around said pipe and an elastomeric line covers the second layer.

In certain embodiments, the fibers may be composite fibers, e.g., embedded in a matrix as described further below.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 is an illustration of a pipe utilizing the reinforced weld seam in accordance with the current invention. FIG. 1 has portions of the layers broken away to better illustrate the present invention.

FIG. 2 is a cross-sectional view of the reinforced weld seam of 15 FIG. 1 as viewed along line 2-2 of FIG. 1.

FIG. 3 is an illustration of a pipe having a weld seam and a raised ring in accordance with the current invention.

FIG. 4 is an illustration of a pipe having a weld seam and raised beads in accordance with the current invention.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### NOTATION AND NOMENCLATURE

As used herein terms “a” “an” “the” and “said” means one or more.

As used herein, the term “and/or”, when used in a list of two or more items, means that anyone of the listed items can be employed by itself, or any combination of two or more of the listed items can be employed. For example, if a composition is described as containing components A, B, and/or

C, the composition can contain A alone; B alone; C alone; A and B in combination; A and C in combination; Band C in combination; or A, Band C in combination.

As used herein, the terms “comprising”, “comprises”, and “comprise” are open-ended transition terms used to transition from a subject recited before the term to or on elements recited after the term, where the element or elements listed after the transition term are not necessarily the only elements that make up the subject.

As used herein, the term “dry” when used to describe fibers means that there is no application of a material, such as plastic, thermoplastic, epoxy, urethane, isophtalic polyester resin or tar enamel, to form a matrix such that a composite material will be formed with the fibers.

As used herein, the term “pipe” refers to any tubular that carries pressurized gasses or liquids, such as a pipeline, a riser, a flow line, and a choke and kill line, for example.

As used herein, the term “conventional strength steel” refers to steel having minimum yield strength of 70,000 psi or less, namely X70 grade or lower grade steel.

As used herein, the term “high strength steel” refers to a steel having a minimum yield strength greater than 70,000 psi, namely greater than X70 grade steel.

As used herein, the term “corrosion resistant alloy” refers to materials containing alloy elements, such as nickel, chromium, titanium, or cobalt. These materials include stainless steels, nickel-cased alloys, titanium alloys, and the like. Commonly used grades are austenitic stainless steels (such as alloy 316), martensitic stainless steels (such as alloy 13 Cr), duplex stainless steels (such as alloy 2205), and nickel-based alloys (such as alloy 625).

### DETAILED DESCRIPTION

The following detailed description of various embodiments of the invention references the accompanying drawings which illustrate specific embodiments in which the invention can be practiced and wherein like reference numbers are used for like features. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of the equivalents to which such claims are entitled.

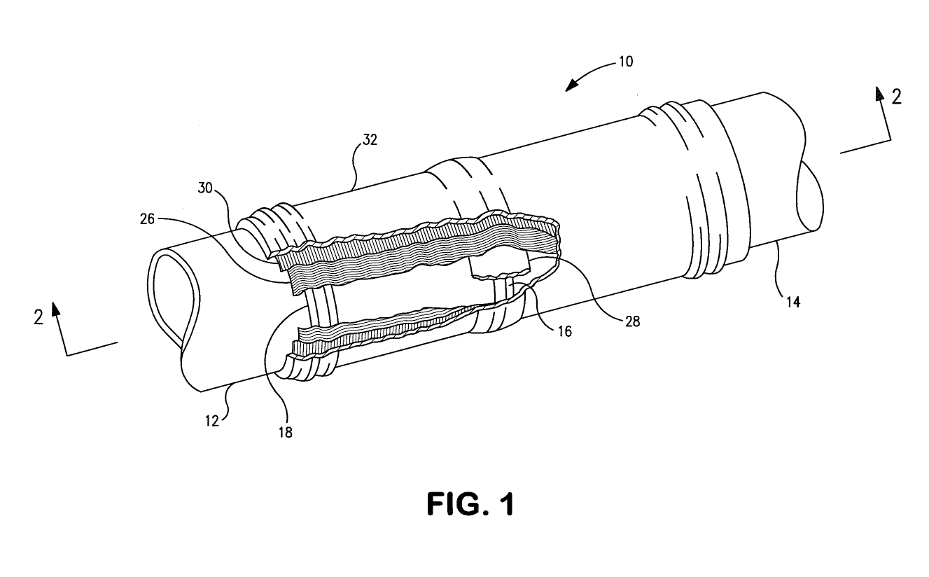

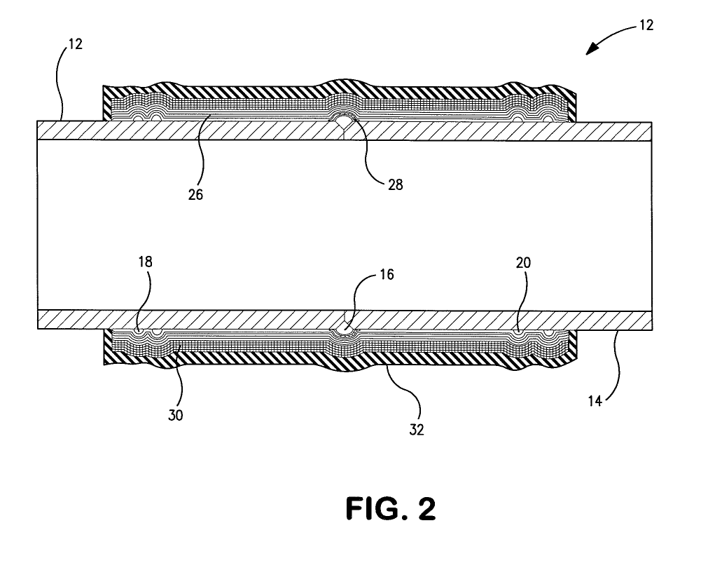

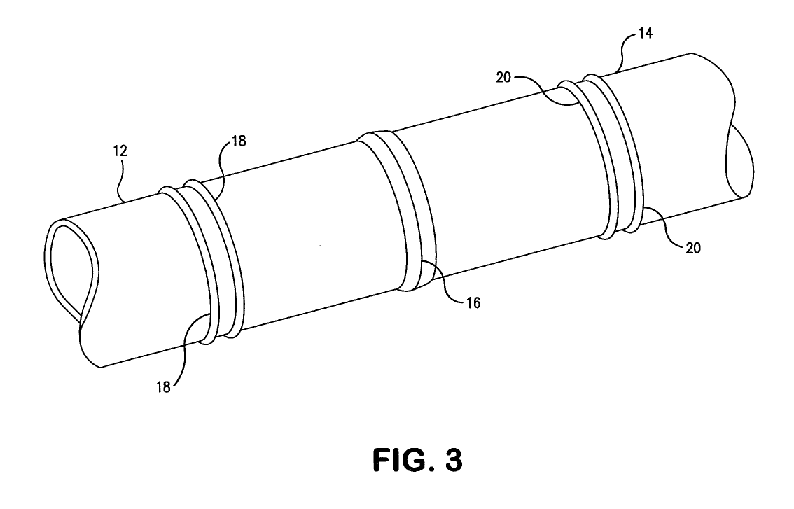

Referring now to FIG. 1 and FIG. 2, a pipe 10 is depicted, which is representative of reinforced pipe in accordance with the current invention. FIG. 1 illustrates pipe 10 with a partial break-away of several layers of the pipe reinforcement. FIG. 2 is a cross-sectional view along line 2-2 of FIG. 1. The reinforced pipe 10 comprises a metal pipe 12 and a metal pipe 14. Pipes 12 and 14 are butt welded together as indicated by weld bead 16. Pipe section 12 has at least one raised member 18 and pipe section 14 has at least one raised member 20. Raised members 18 and 20 can better be seen with reference to FIG. 3.

As depicted in FIG. 3, pipe section 12 has two raised members 18 in the form of a raised ring which comprises a material attached to pipe section 12 such as a metal ring applied by welding, flame spraying, or other suitable means. Similarly pipe section 14 has two raised members in the form of raised rings 20. Accordingly, the raised members are located to each side of the weld. These raised members 18 and 20 serve to anchor the longitudinal layer of fibers as further discussed below.

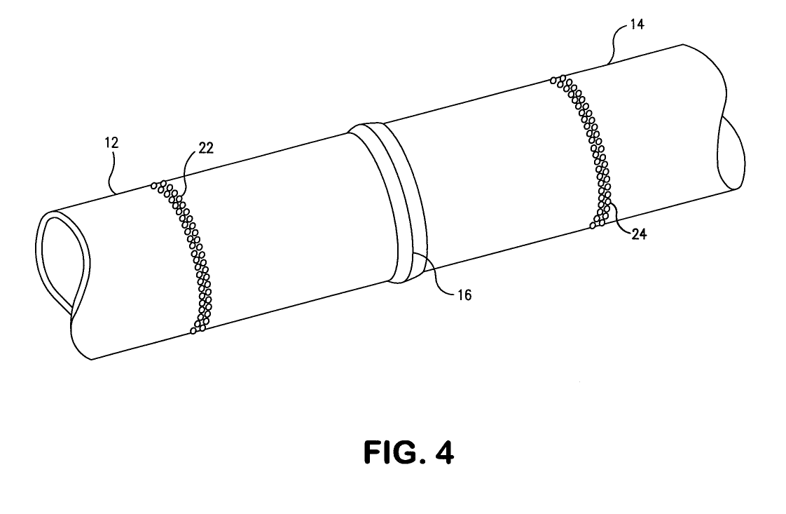

With reference to FIG. 4, a different embodiment for the raised members can be seen. In FIG. 4, instead of the raised members being in the form of a raised ring, the raised members are raised beads 22 and 24 positioned circumferentially around pipe sections 12 and 14, respectively. Raised beads 22 and 24 can be any suitable material that would create raised bumps on the pipe and adhere to pipe sections 12 and 14, such as solder, metal beads or epoxy bumps.

Pipe 10 further comprises a longitudinal layer of fibers 26. Fibers 26 extend generally longitudinally down a portion of pipe 10 such that fibers 26 cover raised members 18 and 20 as well as weld 16. In order to protect the dry fibers 26 from marring from the weld seam, it is preferred that a protective fabric 28 is positioned between the fibers 26 and the weld seam 16. Circumferentially fiber layer 30 is applied to cover longitudinally dry fiber layer 26. Circumferential dry fiber layer 30 extends generally circumferentially around the pipe such that the fibers run preferably substantially perpendicular to the fibers in longitudinal dry fiber layer 26. Generally, dry fiber layers 26 and 30 will comprise a ribbon of multiple parallel strands with each strand consisting of continuous filaments. Encasing the fiber layers is an external line 32, such as a sprayed-on external elastomeric binder. One skilled in the art will recognize that other material layers may optionally be included to cover the fiber layers, such as a layer of thermal insulation material like Areogel, for example.

Although the invention can be useful for smaller diameter and conventional strength steel pipes and other non-steel metal pipes, it is believed the best benefit and preferred application of the invention is in larger diameter pipes such as large diameter natural gas pipelines generally ranging from about 36 inches to about 54 inches in diameter. Additionally, it is believed that the most benefit and preferred use is in steel pipes that are considered to be high strength steel. A short-hand terminology has been developed by the American Petroleum Institute (API) Specification 5L to designate grades of line pipe steel using letter “X” followed by a number corresponding to its minimum yield strength. For example, XI00 steel has minimum yield strength of 100,000 pounds per square inch (psi), and similarly, X120 steel has a minimum yield strength of 120,000 psi. Generally, grade X70 or lower is considered “conventional strength steel,” whereas grades above X70 are considered high strength steel, typically beginning at grade X80.

In one embodiment of the current invention, the metal pipe 10 may be constructed of a corrosion resistant alloy for transporting corrosive gas or liquids. The invention is particularly desirable for large diameter (greater than 36 inches) pipelines made from high strength steel.

The fiber layers 26 and 30 may be in the form of a composite material by having the fibers embedded in a matrix material or by having a resin capable of forming a matrix applied to the fibers either before or after the fibers are place on pipe 10. If the later technique is used, then the fiber/resin layer will need to be cured after it is applied to pipe in order to form the composite material. The matrix material can be a curable viscous liquid substance such as an epoxy, coal tar enamel, urethane, isophthalic polyester resin or other similar type material. If dry fibers are used for fiber layers 26 and 30, they should be comprised of a ribbon of multiple parallel strands with each strand consisting of a plurality of or many continuous filaments such as a bundle of glass fiber, carbon fiber, high density polyethylene fiber, amid fiber (such as, Kevlar fiber) or other similar material.

During use of the pipe and as the pipe is subject to ground movement or pipe movement, the weld seam 16 undergoes stress in a cross weld direction. The purpose of the longitudinal fiber layer 26 is to help reinforce the weld seam and shield the weld steam from cross weld strain. By utilizing a longitudinal fiber layer 26, the strain capacity of the weld joint (both compressive and tensile) is elevated. Because this is a local application, a means to anchor the ends of the axle or longitudinal (cross-weld) fibers is needed. The raised member along with a circumferential fiber layer 30 and/or external line 32 provides such an anchoring. Obviously, as the weld seam 16 is strained in a cross-weld direction, the fibers will naturally tend to pull outward and away from the metal surface. This outward motion is restrained by the wrap of fibers in the circumferential direction or, optionally, external line 32. Additionally, the raised members 19 and 20 help provide additional prevention of the longitudinal fibers moving in an axle or longitudinal direction along the pipe. In addition to anchoring the ends of the longitudinally aligned fibers 26, the circumferentially aligned fibers 30 can also serve to restrain pipe metal movement outward when the pipe is under pressure and compressive stresses are applied along the pipe axis. According to the compressive buckling theory of pipes under pressure, the pipe wall moves outward at the start of buckling. It is thought that the restriction of the outward movement by the circumferential fibers will add compressive strain (buckling) capacity to the pipe.

In a preferred embodiment, an external liner 32 surrounds the fiber layers 26 and may comprise an elastomeric liner such as polyurea or polyurethane, a rubber-like HNBR rubber or other similar material.

In another embodiment, the external liner 32 may comprise welded metal wrapping formed around the fiber layers 26 and 30. The purpose of the external liner is two-fold. First, the dry fiber layers may be loose such that external liner 32, when sprayed on or wrapped over the dry fiber layers, acts to hold the dry fiber layers together onto the metal pipe. Second, the external liner may act as a moister barrier to prevent moister from becoming trapped within the dry fiber layers and eventually causing corrosion along the outer surface of the metal pipe 10. One skilled in the art may readily appreciate that the thickness of the external liner 32 may also vary.

It is explicitly recognized that any of the elements and features of each of the devices described herein are capable of use with any of the other devices described herein with no limitation. Furthermore, it is explicitly recognized that the steps of the methods herein may be performed in any order except unless explicitly stated otherwise or inherently required otherwise by the particular method.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations and equivalents are considered within the scope and spirit of the present invention. Also, the terms in the claims have their plain, ordinary meaning unless otherwise explicitly and clearly defined by the patentee.

What is claimed is:

1. A reinforced pipe comprising:
a first metal pipe section butt welded to a second metal pipe section to form a weld seam;
a first raised member located a first distance away from said weld seam on said first metal pipe section;
a second raised member located a second distance away from the weld seam on said second metal pipe section; and
a first layer of fibers disposed generally longitudinally along said pipe so that said first layer covers said first raised member, said weld seam and said second raised member.

2. The reinforced pipe section of claim 1 wherein said first raised member comprises a series of raised beads positioned generally circumferentially around said first pipe section.

3. The reinforced pipe section of claim 2 wherein said second raised member comprises a series of raised beads positioned circumferentially around said second pipe section.

4. The reinforced pipe section of claim 1 wherein said first raised member comprises a raised ring positioned circumferentially around said first pipe section.

5. The reinforced pipe section of claim 1 wherein said second raised member comprises a raised ring positioned circumferentially around said second pipe section.

6. The reinforced pipe section of claim 1 wherein said first layer comprises a ribbon of multiple parallel strands with each strand comprising many continuous filaments.

7. The reinforced pipe section of claim 1 wherein said first layer comprises dry fibers.

8. The reinforced pipe section of claim 1 further comprising a second layer of fibers disposed generally circumferentially around said pipe to substantially cover said first layer.

9. The reinforced pipe section of claim 8 further wherein said second layer comprises a ribbon of multiple parallel strands with each strand comprising many continuous filaments.

10. The reinforced pipe section of claim 9 further comprising an external liner covering said first layer and said second layer.

11. The reinforced pipe section of claim 10 wherein said external liner comprises an elastomeric liner.

12. The reinforced pipe section of claim 1 further comprising an external liner covering said first layer.

13. The reinforced pipe section of claim 1 wherein said first layer increase the compressive strain capacity of the weld seam.

14. The reinforced pipe section of claim 1 wherein said first layer increase the tensile strength of the weld seam.

15. The reinforced pipe section of claim 1 wherein said first raised member comprises a raised ring positioned circumferentially around said first pipe section and said second raised member comprises a raised ring positioned circumferentially around said second pipe section.

16. The reinforced pipe section of claim 15 further comprising a second layer of fibers disposed generally circumferentially around said pipe to substantially cover said first layer wherein said second layer comprises a ribbon of multiple parallel strands with each strand comprising many continuous filaments.

17. The reinforced pipe section of claim 16 wherein said first layer comprises a ribbon of multiple parallel strands with each strand comprising many continuous filaments and wherein said first layer and said second layer comprising dry fibers.

18. The reinforced pipe section of claim 17 further comprising an external liner covering said first layer and said second layer wherein said external liner comprises an elastomeric liner.

19. A reinforced pipe comprising:
a first metal pipe section butt welded to a second metal pipe section to form a weld seam;
a first raised ring positioned circumferentially around said first pipe section and located a first distance away from said weld seam on said first metal pipe section;
a second raised ring position circumferentially around said first pipe section and located a second distance away from the weld seam on said second metal pipe section;
a first layer of dry fibers disposed generally longitudinally along said pipe so that said first layer covers said first bead line, said weld seam and said second bead line and wherein said first layer comprises a ribbon of multiple parallel strands with each strand comprising many continuous filaments; a second layer of dry fibers disposed generally circumferentially
around said pipe to substantially cover said first layer and wherein said second layer comprises a ribbon of multiple parallel strands with each strand comprises many continuous filaments; and
an external elastomeric liner covering said first layer and said second layer.

20. A reinforced pipe comprising:
a first metal pipe section butt welded to a second metal pipe section to form a weld seam;
a first raised member located a first distance away from said weld seam on said first metal pipe section;
a second raised member located a second distance away from the weld seam on said second metal pipe section; and
a first layer of fibers disposed generally longitudinally along said pipe so that said first layer covers said first raised member, said weld seam and said second raised member, wherein at least a portion of the fibers comprise composite fibers embedded in a matrix material.
